(19) United States
(12) Patent Application Publication
(10) Pub. No.: US 2006/0225323 A1
(43) Pub. Date: Oct. 12, 2006

(54) Interactive run-in-place model vehicle display

(75) Inventors: Gerard S. Calabrese, Montclair, NJ (US); Tammy Lynn Condeelis, Marine City, MI (US)

Correspondence Address: BRIAN M BERLINER, ESQ;O'MELVENY & MYERS, LLP, 400 SOUTH HOPE STREET, LOS ANGELES, CA, 90071-2899, US

(73) Assignee: LIONEL L.L.C

(21) Appl. No.: 11/093,918

(22) Filed: Mar. 29, 2005

(51) Int. Cl. G09F 19/08

(52) U.S. Cl. 40/423

(57) ABSTRACT

An interactive run-in-place model vehicle display includes a model vehicle, such as a model train, mounted to a base. The model vehicle includes motorized drive wheels that are suspended slightly over a model track or other simulated road base. The display includes a user interface for controlling operation of the motorized drive wheels. The motorized drive wheels may be operated so as to rotate freely without contacting the model track or base. Vehicle sounds may be generated by a sound generator located in the model vehicle or in the base. The model vehicle may be covered by a transparent case.

### BACKGROUND OF THE INVENTION

1. Field of the Invention

The present invention relates to decorative displays, and more particularly, to a decorative display incorporating an interactive run-in-place model vehicle, such as a model train.

2. Description of Related Art

Model vehicles of various types are known in the art. Some model vehicles are provided with a motive power, such as an electric motor or other engine, to cause the model vehicle to move. For example, model trains are often provided with an electric motor, which is designed to draw power through a rail of a metal train track. Model trains and other vehicles may also incorporate other powered accessories, such as sound generators, smoke or vapor generators, and actuators of various types, intended to make the operation of the model vehicle more complex and engaging. The model track rail is often powered via a power transformer or the like. To use the model train, a user is therefore required to construct a layout of model train track and to power the model track appropriately.

Some users, however, may desire to have an operating model train or other vehicle, without the inconvenience or expense of constructing a model track layout. For example, many model vehicles, and model trains in particular, are constructed with exquisite detail and realism, such that train aficionados and others might consider them to make fine decorative items. However, few would purchase an operable model train merely as a display piece. And when the model train is used as a display piece, it generally cannot be operated.

Previously, for limited applications such as merchant displays, it was known to place model trains on a specially-constructed section of track. The special track section incorporated rollers disposed in or adjacent to the rails under the drive wheels of the model vehicle. The track was otherwise powered normally, such as by using a transformer or the like. A merchant would place a model train to be displayed on the special track, with the drive wheels resting on the rollers. Thus, the train could receive power from the special track section and be operated normally, without moving. Instead, the rollers would rotate in place when the drive wheels were driven, and the model train could be operated while remaining stationary. This type of mount is sometimes referred to as “run-in-place.” The special track section, or “base” was designed to be used with a variety of different model trains, which might be replaced frequently as a merchant rotated inventory or promoted different models, or by a hobbyist.

Notwithstanding their advantages, prior-art run-in-place mounts were best suited for temporary stationary display of otherwise fully-operational model trains, and are therefore subject to certain disadvantages. For example, displays of this type are not very secure in that the train may be removed from the base, increasing the risk of toppling or other unintended displacement. Such unsecured displays may be less suitable for residential display locations, for example on a bookshelf or fireplace mantle. In addition, the rollers of prior-art run-in-place displays may be subject to wear, increases in rolling resistance, misalignment, lubrication failure, excessively noisy operation, or other problems. In the merchant setting, such problems may be solved by regular maintenance and repair, but in a residential display, such requirements are much less acceptable. Busy residential consumers may be much less interested in a display that requires substantially more maintenance than regular dusting. Still further, prior-art run-in-place displays require the use of regular model train power supplies and fully operational model trains. Both of these factors tend to raise the cost and inconvenience of run-in-place displays, discouraging more widespread use.

It is desirable, therefore, to provide an interactive run-in-place display for a model vehicle, that overcomes these and other limitations of the prior art.

### SUMMARY OF THE INVENTION

The present invention provides an interactive run-in-place display for a model vehicle, such as a model train, that is more suitable for decorative applications than prior art displays. The display is more user-friendly, more convenient, safer, and may be provided at a lower cost than prior-art displays, while preserving comparable visual and audible effects.

In an embodiment of the invention, the display comprises three principal components: a model vehicle, such as a model train; a mount, such as a section of railway with mounting brackets for the model engine; and a base, which may be decorative in appearance and attached to a user interface for operating the display. Optionally, the model vehicle may be covered by a clear case mounted to the base. A remote user interface may be provided, in addition to, or in the alternative to, the user interface provided on the base.

The base may be hollow or otherwise comprise an interior space for holding electronic components of the display, such as a power supply, sound generator, controller, power converter, receiver for a remote interface, clock or timer, or other components. In the alternative, or in addition, some such components may be located in an interior space of the model vehicle. In an embodiment of the invention, the base is supplied with power via a power cord designed to mate with a household AC electric socket. The power cord may incorporate a “wall pack” power transformer or other power converter for rectification or voltage reduction, as known in the art. The base should be generally rigid and sturdy. It may be generally decorative in appearance, and may include legs or other standoffs on a lower surface, for resting on a flat surface. The base may be any suitable shape, such as a generally rectangular prism shape, that is elongated to match the length of the model train, and ornamented as desired. Other shapes may also be suitable, such as curved or flared bases, or irregular-shaped bases designed to mimic a landscape.

A vehicle mounting system is attached to or integrated with an upper surface of the base. For a model train, the mounting system may comprise a short section of model train track, or simulated model train track, and one or more mounting brackets, tabs, bosses, or other structures for holding the model vehicle in place. The mounting structures may be designed to hold the drive wheels of the model train just slightly above the model train track, so as to be very close but not in contact with the track. Any remaining wheels may be permitted to rest on the track rails. The mounting structures should be designed to attach to the model vehicle using any suitable fasteners, e.g., screws, clips, studs, etc.

The model vehicle may comprise a fully operational model vehicle that is mounted to the base with its drive wheels held just above the track or simulated track. In an embodiment of the invention, the model vehicle may be specially constructed for display only. As such, it may lack certain components found in operating model vehicles, or may be constructed of different materials. But whether operational, or for display only, the model vehicle should comprise driving wheels and a motor for turning the driving wheels, and should be mounted to the base with the driving wheels suspended over the rail. The model vehicle may receive power through one or more direct connections made to power or control units located in the base. In the alternative, the model vehicle may receive power and control signals via the track section, or via a wireless connection, in the manner of a conventional model vehicle.

A rigid clear display case, such as a molded plastic or glass cover, may be provided over the model vehicle, and may be engaged with or attached to the base. Advantageously, the display case prevents accumulation of household dust or dirt on the model vehicle, without obscuring the vehicle.

A panoramic image or other background may be provided behind the model vehicle. The background may be supported by the base, or in the alternative, by the display case.

Thus, a run-in-place display may be provided for a model vehicle, that provides all the advantages of prior-art run-in-place displays, while overcoming their disadvantages, and providing additional features and advantages. A more complete understanding of the interactive run-in-place model vehicle display will be afforded to those skilled in the art, as well as a realization of additional advantages and objects thereof, by a consideration of the following detailed description of the preferred embodiment. Reference will be made to the appended sheets of drawings, which will first be described briefly.

### BRIEF DESCRIPTION OF THE DRAWINGS

FIG. 1 is a block diagram showing an exemplary interactive run-in-place model vehicle display according to the invention.

### DETAILED DESCRIPTION OF THE PREFERRED EMBODIMENT

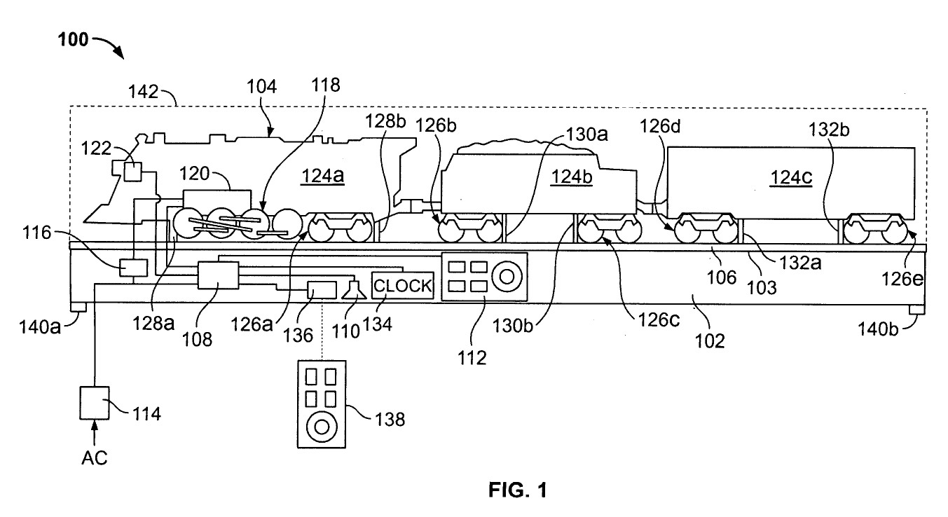

The present invention provides a run-in-place decorative display for a model vehicle, that is safer and more convenient than prior art run-in-place displays. FIG. 1 is a block diagram showing an exemplary decorative display 100. FIG. 1 should not be interpreted as limited to a single appearance or arrangement of components of a display within the spirit and scope of the invention. Rather, FIG. 1 is intended to aid understanding of the inventive concepts of the invention in a general sense. One of ordinary skill may apply these concepts to build a variety of different embodiments of the invention.

Display 100 may comprise a base 102 having an upper surface 103 on which a section of model track 106 and a model vehicle 104 are mounted. Model vehicle 104 may comprise any number of cars coupled together, for example, cars 124a, 124b, and 124c. The invention is not limited to a particular arrangement or style of cars. However, at least one car 124a should comprise a locomotive having a set of motorized drive wheels 118, which may be linked together in any suitable fashion as known in the art of model trains. Drive wheels 118 may be driven by an electric motor 120. In an embodiment of the invention, motor 120 comprises a DC electric motor. An AC motor may also be used. Cars 124a-c may also comprise non-motorized wheels 126a-e, which may rest on model track 106. Model track 106, in turn, may be mounted to upper surface 103.

Upper surface 103 may have any suitable configuration, for example, flat and generally level. In the alternative, surface 103 may be inclined. In addition, surface 103 may be provided with contours, attached features, or objects to simulate a landscape or trackside environment, such as to create a decorative effect or theme. Model track 106 may comprise a piece of model train track such as used for electric or steam powered model trains, such as comprises two or three parallel metal rails. In the alternative, track 106 may comprise a simulated track section, such as a piece of molded plastic or other material that is decorated so as to appear like a model railroad track. In an embodiment of the invention, the length of the base 102 is slightly longer, or only somewhat longer, than model train 104. In the alternative, a longer track section may sometimes be desirable, for example, in displays where it is desired to provide a more elaborate modeled landscape or rail-side environment.

Base 102 may comprise any suitable material, for example, wood, metal, plastic, or any combination of the foregoing. The base may comprise an interior space or compartment for housing electronic and mechanical components of the system, for example, a controller 108 and user interface 112. Advantageously, base 102 may be of sturdy construction with an attractive exterior. It may be any suitable shape, for example, rectangular prism-shaped, cylindrical, or irregular. An irregular shape may be desirable for simulating a landscape setting for the model vehicle. The base may comprise a space suitable for attachment of a plaque or label.

Model vehicle 104 may be mounted to base 102 using any suitable fasteners and support structures. Motorized drive wheels 118 should be suspended slightly over rails of track 106, so as to appear, as much as possible, to touch the track without actually making contact. This arrangement permits the motorized wheels to spin freely when driven, without giving rise to any motive force on the train or wear on the wheel. And because the drive wheels are suspended, there are no rollers or other moving supports, which are subject to maintenance requirements and other disadvantages. Very light motor loads are an additional advantage to this arrangement, making it feasible to use a smaller motor designed for a lighter duty cycle than would otherwise be necessary to power the drive wheels.

One of ordinary skill may devise various suitable mounting structures for mounting the model vehicle to the base with the drive wheels slightly suspended over the rails. Mounting structures 128a-b under car 124a, structures 130a-b under car 124b, and structures 132a-b under car 124c should be understood as merely diagrammatic, and are not intended to depict actual mounting structures. The depicted shapes may not be optimal for mounting a model vehicle. In addition, mounting structures should be concealed behind respective wheel sets 118 and 126a-e, so as to be virtually invisible when viewing display 100, at least from its front.

It may be desirable to provide display 100 with some or all of the features found on real model trains, such as lights, sounds, and other active features. Accordingly, display 100 may be provided with a control system for the drive motor 120, sound generator 110, lights 122, or other accessories. Either an analog or digital control system may be provided. Both types of control systems are well-understood in the art, and need not be described here. As shown in the illustrated embodiment, a control system may comprise an analog or digital controller 108, such as any suitable programmable logic controller, operably connected to motor 120 for drive wheels 118, a sound generator 110 for producing simulated vehicle sounds, a simulated lamp 122, and a user interface such as a keypad 112.

Optionally, the control system may additionally comprise a clock or timer 134, with or without a display of current time-of-day or other time interval. Input from the clock or timer may be used to control operation of features of the display; for example, the motor or other accessories may be automatically shut down after a defined interval of time. For further example, features of the display may be activated at specific times of day to provide an indication of current time. Clock 134 may include a display, such as a digital clock display or analog clock face, which may be used as both decorative and functional features of base 102. In an embodiment of the invention, display 100 may function as a clock, and operate automatically to mark intervals of time. For example, the motor could be operated and a horn sound generated on the hour, and a bell sound generated on the half hour.

Active features of display 100 and control systems, for example sound generators and controllers, may be located in either the base 102 or in the model vehicle 104. In embodiments where the model vehicle will not be removed from the base, accessories such as a sound generator 110 may be provided in or adjacent to the base. For example, base 102 may comprise an interior space where the sound generator, control system components, or other operating features of the display may be operated. In the alternative, some or all control components may be located in model vehicle 104.

As used herein, a sound generator may comprise one or more loudspeakers and electronics as known in the art for driving the speakers. In addition, a suitable sound generator may comprise an audio chip or electronics for generating simulated sounds, such as operating sounds of a train, crossing bells, or any other desired sound. In the alternative, sounds may be generated by controller 108, or retrieved from a memory of the control system. In an embodiment of the invention, a memory may be operably associated with the controller 108, and may hold sound clips, also known as audio files, for play by the sound generator. Sound clips may include train sounds or other vehicle sounds, musical sounds, spoken words, songs, narrative, or any other desired sound. It may be possible to thereby provide theme music for the display, for example, a rendition of “I've Been Working on the Railroad” may be appropriate for a train display. Sound clips may be selected to appeal to defined groups of individuals. For example, anthems or other sounds associated with various organizations may appeal to members of the respective organizations. The memory may also be configured to be accessible by a user, to permit the addition of personalized or personally selected sound clips.

Active features of display 100 should be subject to user control via one or more user interfaces 112, 138. Either or both user interfaces may incorporate a keypad, switches, knobs, or other input devices for controlling the operative features of the display. Either or both interfaces 112, 138 may be operably connected to controller 108, which may control operation of motor 120, sound generator 110, light 122, and any other operative features of display 100. For example, user interface 112 may be connected to controller 108 via a wire. In the alternative, or in addition, user interface 138 may be connected via a wireless connection and receiver 136 to the controller. Either or both user interfaces may comprise a display screen (not shown) for providing instructions or other messages to a user. Display 100 may comprise multiple interfaces like interfaces 112, 138, or one only, which may be of either type. In addition, or in the alternative, display 100 may be operated using one or more simple on/off switches configured for controlling power to one or more operative features of the display.

Power for display 100 may be supplied via a wall-pack transformer 114, as known in the consumer electronic arts for powering low-voltage apparatus. Wall pack 114 may be equipped with a standard household plug on one end, and a connector configured to mate with a corresponding connector in base 102, at an opposite end of a connecting cord. The electronics of the wall pack may, in the alternative, be provided in or adjacent to the base, with a cord or other connection to a wall outlet. If motor 120 is selected to be a DC motor, input power may be rectified using a rectifier 116 as known in the art, before providing to motor 120. Other methods of providing input power, for example, batteries or different power distribution systems, may also be used. For example, a rechargeable battery pack may be provided in the base or in a separate unit. The battery pack may be recharged using a wall pack transformer, or a transformer in the base 102. In the alternative, or in addition, the battery pack may be used with non-rechargeable batteries.

Operative features such as motor 120 or light 122 in the model vehicle 104 may be operably connected to control or power circuits in the base using any suitable connection. In embodiments of the invention wherein the model vehicle is not to be removed from track 106, wires may be used to make a secure and inexpensive connection. Such wires should be concealed behind wheels of the model vehicle or otherwise concealed so as to make an inconspicuous connection. In the alternative, operative connections for either or both power and control signals may be established via track 106, using methods as known in the art of model trains. Likewise, any suitable wireless connection may be used.

It may be desirable to provide a transparent case 142 for display 100. A display case may be configured to fit over model vehicle 104 and rest over base 102. Case 142 may be constructed of any suitable transparent material, for example, plastic or glass. A panoramic display or other backdrop may be mounted to the case 142 behind the model vehicle, if desired. A backdrop may also be painted, etched, engraved, or otherwise provided in or on the material of the case itself. In the alternative, a backdrop or background features may be mounted to base 102, or omitted entirely.

Having thus described a preferred embodiment of an interactive run-in-place model vehicle display, it should be apparent to those skilled in the art that certain advantages of the within system have been achieved. It should also be appreciated that various modifications, adaptations, and alternative embodiments thereof may be made within the scope and spirit of the present invention. For example, a model train display has been illustrated, but it should be apparent that the inventive concepts described above would be equally applicable to other model vehicles, such as cars, trucks, ships, and planes. The invention is further defined by the following claims.

What is claimed is:

1. A run-in-place display for a model train, comprising:
a base comprising an upper surface configured for mounting a section of model train track;
a section of model track mounted to the base; and
a model train mounted to the upper surface of the base, the model train comprising motorized drive wheels that are free to rotate when driven, wherein the model train is positioned with the motorized drive wheels suspended a slight distance over the section of model track, such that the model train remains stationary when the motorized drive wheels are driven.

2. The run-in-place display of claim 1, further comprising a controller operably connected for operation of the motorized drive wheels.

3. The run-in-place display of claim 2, further comprising a sound generator operably connected to the controller.

4. The run-in-place display of claim 2, further comprising a user interface operably connected to the controller.

5. The run-in-place display of claim 4, wherein the user interface comprises a keyboard and is configured for sending control signals to the controller for controlling operation of the motorized driver wheels.

6. The run-in-place display of claim 1, wherein the user interface comprises a wireless remote control device.

7. The run-in-place display of claim 3, further comprising a memory operably associated with the controller, the memory holding information comprising at least one sound clip for play by the sound generator.

8. The run-in-place display of claim 3, wherein the at least one sound clip is selected from train sounds, musical sounds, spoken sounds, and singing.

9. The run-in-place display of claim 3, further comprising a clock operably associated with the controller, whereby the controller is configured to activate at least one component selected from the motorized drive wheels and the sound generator at periodic intervals.

10. The run-in-place display of claim 9, wherein the clock further comprises a timepiece visibly mounted to the base.

11. The run-in-place display of claim 1, wherein at least one component selected from the controller and the sound generator are disposed in the base.

12. The run-in-place display of claim 11, wherein the at least one component is connected to the model train via a wire.

13. The run-in-place display of claim 1, further comprising a transparent case disposed over the model train and resting on the base.

14. The run-in-place display of claim 13, wherein the transparent case further comprises a backdrop image formed in a material of the transparent case.

15. The run-in-place display of claim 13, wherein the backdrop image comprises an etching or engraving.

16. The run-in-place display of claim 1, wherein the upper surface of the base is contoured to simulate a landscape.

17. The run-in-place display of claim 1, further comprising a panoramic backdrop disposed behind the model train.

18. The run-in-place display of claim 1, wherein the base comprises a decorative wood material.

19. The run-in-place display of claim 1, wherein the motorized drive wheels of the model vehicle are connected to a power source via a wire passing through the base.

20. The run-in-place display of claim 1, further comprising a wall-pack power supply configured for connecting to the base.

21. The run-in-place display of claim 1, wherein the model train further comprises non-motorized drive wheels resting on the model track.
